(19) United States
(12) Patent Application Publication
(10) Pub. No.: US 2005/0070161 A1
(43) Pub. Date: Mar. 31, 2005

(54) Modular jack with external electromagnetic shielding

(76) Inventor: Steven David Dunwoody, Middletown, PA (US)

Correspondence Address: Robert Kapalka;Tyco Electronics Corporation, Suite 140, 4550 New Linden Hill Road, Wilmington, DE, 19808, US

(21) Appl. No.: 10/670,657

(22) Filed: Sep. 25, 2003

(51) Int. Cl. H01R 13/66

(52) U.S. Cl. 439/620

(57) ABSTRACT

A modular receptacle jack includes a housing having a jack interface and an exterior surface. A shield extends over at least a portion of the exterior surface, and the shield comprises an interior face and an exterior face. A plurality of magnetic components are coupled to one of the interior face and the exterior face for suppressing EM/RFI.

### BACKGROUND OF THE INVENTION

The invention relates generally to electrical connectors, and, more particularly, to a modular jack having electromagnetic interference and radio frequency interference (EMI/RFI) shielding and integral EMI suppression components.

Conventional modular jacks include a housing having a plug-receiving receptacle on one face thereof, and a plurality of stamped, metallic elongated contacts mounted in the housing for engaging contacts of a corresponding plug when the plug is inserted into the receptacle. Such modular jacks are mountable in a cutout of a panel at an input/output port of an electronic apparatus such as a computer, networking hub, router, or interfacing (NIC) card.

When used in digital communications systems, the devices in which this type of modular jack is used have a tendency to emit high frequency radiation, which can interfere with other electrical equipment. Some known modular jacks include a conductive shell mounted to the exterior of the jack housing to prevent the signal circuits through the modular jack from emitting electromagnetic and radio frequency interference (EMI/RFI). The shell member is electrically connected to a ground circuit of the associated apparatus to dissipate undesirable interference. See, for example, U.S. Pat. No. 5,766,041.

In addition, in digital communication systems, the devices in which modular jacks are used are themselves vulnerable to noise or transients induced in an incoming line by external sources and transmitted through the modular jack. Some modular jacks therefore include magnetic components within the jack and internal to the conductive shell surrounding the jack for filtering the signal lines within the jack. A connection is made from an internal ground to the conductive shell, or to a logic ground to suppress undesirable components in the signal lines. See, for example, U.S. Pat. No. 5,397,250.

It is believed, however, that this connection from an internal ground to the conductive shell or to a logic ground, made necessary by magnetic component placement internal to the jack and the conductive shell, results in crosstalk and increased emissions. Crosstalk occurs due to common impedance coupling in its self inductance. Self inductance causes a voltage drop that will radiate EMI from cable signal conductors. For the same reasons, susceptibility of the modular jack to EMI/RFI may actually be increased with attempts to filter signals within the receptacle jack.

It would be desirable to provide a modular jack with shielding to capably avoid undesirable EMI/RFI attributable to both the device in which the modular jack is used and to external sources transmitted to the jack via an incoming communications line.

### BRIEF DESCRIPTION OF THE INVENTION

In an exemplary embodiment, a modular receptacle jack comprises a housing comprising a jack interface and an exterior surface. A shield extends over at least a portion of the exterior surface, and the shield comprises an interior face and an exterior face. A plurality of magnetic components are coupled to one of the interior face and the exterior face for suppressing EMI.

Optionally, the receptacle jack is an RJ-45 jack, and at least some of the magnetic components comprise transformer elements. The shield comprises a printed circuit board, and the printed circuit board comprises a ground plane. A conductive shell surrounds at least a portion of the jack, and the shield is coupled to the conductive shell.

According to another exemplary embodiment of the invention, a modular receptacle jack is provided. The jack comprises a housing comprising a jack receptacle and a plurality of signal contacts within the receptacle. A shield extends over an outer surface of the housing, and the shield comprises a printed circuit board and a plurality of magnetic components coupled to a surface of the printed circuit board for suppressing EMI transmission by the contacts.

According to another embodiment, a modular receptacle jack is provided. The jack comprises a housing comprising a jack receptacle, and a plurality of signal contacts within the receptacle, and a shield extending over an outer surface of the housing. The shield comprises a printed circuit board having at least one aperture therethrough for passage of a signal conductor, and at least one magnetic component coupled to a surface of the printed circuit board adjacent the aperture for suppressing EMI transmission therethrough.

### BRIEF DESCRIPTION OF THE DRAWINGS

FIG. 1 is a side schematic view of an exemplary electronic apparatus including a modular jack assembly having an EMI/RFI shield formed in accordance with an exemplary embodiment of the invention.

FIG. 2 is an assembly view of a modular receptacle jack assembly shown in FIG. 1.

FIG. 3 is a schematic illustration of a rear side of the shield shown in FIGS. 1 and 2.

FIG. 4 is a magnified view of a portion of FIG. 3.

FIG. 5 is an exploded view of an exemplary EMI/RFI shield formed in accordance with an exemplary embodiment of the invention.

FIG. 6 is a cross sectional view of the modular jack assembly shown in FIG. 2.

FIG. 7 is an assembly view of another modular receptacle jack assembly formed in accordance with an exemplary embodiment of the invention.

### DETAILED DESCRIPTION OF THE INVENTION

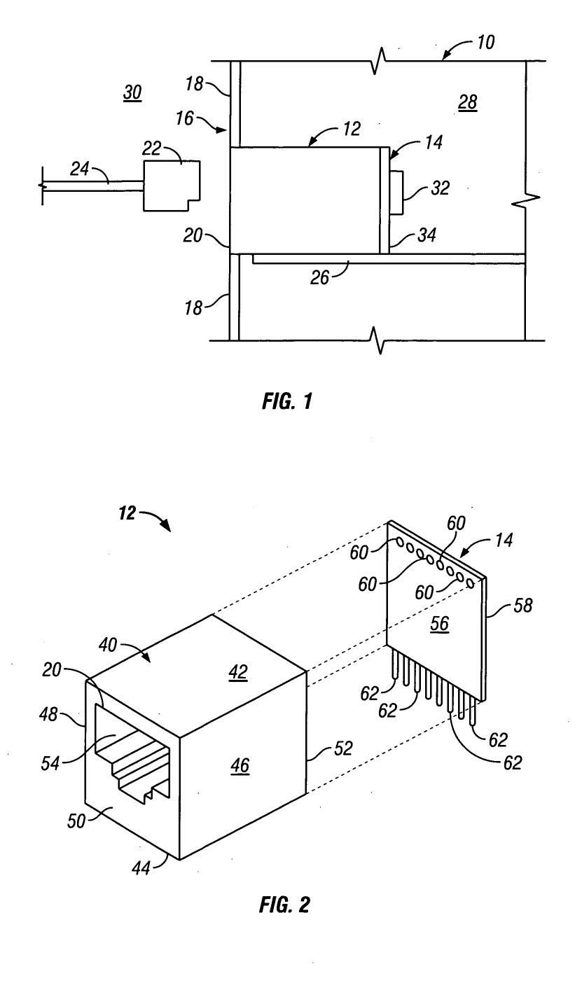

FIG. 1 is a side schematic view of a portion of an exemplary electronic apparatus 10 including a modular jack 12 having an EMI/RFI shield 14 formed in accordance with an exemplary embodiment of the invention.

The electronic apparatus 10 is a known device, and in various embodiments may be a computer, networking hub, router, an interfacing (NIC) card, or other apparatus having a communications port or input/output port 16 through which the apparatus 10 may communicate with external networked devices via the modular jack 12. The exemplary apparatus 10 includes a bezel 18 having a cutout portion therein, and a jack interface 20 of the modular jack 12 is positioned in the cutout portion of the bezel 18 such that the jack interface 20 is accessible for receiving a known modular plug 22. The plug 22 is coupled to a communications line or cable 24 for connection to another networked device (not shown) with which apparatus 10 communicates in operation.

The modular jack 12 is electrically coupled to a printed circuit board, such as a motherboard 26, of the apparatus 10, and the motherboard 26 transmits and receives signals to and from the external networked device through the modular jack 12, the plug 22 and the cable 24 via respective conductors and contacts therein. In an illustrative embodiment, the communications protocol for the apparatus 10 functions in a four pair, eight signal wire platform. That is, the modular jack 12 includes eight signal contacts (not shown in FIG. 1) arranged in four signal differential pairs, the plug 22 includes eight signal contacts (not shown) arranged in four signal pairs corresponding to the pairs in the modular jack 12, and the cable 24 includes eight signal conductors configured in four twisted pairs as those in the art will appreciate. It is appreciated, however, that greater or fewer signal contacts and conductors may be provided in alternative embodiments, with or without differential pair arrangement of the contacts and conductors.

The apparatus 10 includes an interior space 28 having a number of active electrical components and devices (not shown) that produce electromagnetic fields and high frequency radiation, and other components which may induce electromagnetic interference and radio frequency interference (EMI/RFI), collectively referred to herein as “noise”, in signals passing through the modular jack 12. The same noise will radiate from cable 24 causing interference (EMI) to other unrelated devices in the same quiet external space 30. Shielding the modular jack 12 from the interior space 28, sometimes referred to as “noisy space” is therefore desirable to avoid transmission of noise from interior space 28 of the apparatus 10 to the comparatively quiet external space 30.

In addition, the apparatus 10 is vulnerable to incoming noise or transients induced by external sources and transmitted to the modular jack 12 through the cable 24 and the plug 22. Incoming noise in the signals may degrade communication between the external networked device and the apparatus 10 and may negatively influence operation of the apparatus 10.

The shield 14 effectively shields both noise inputs from the quiet external space 30 to the noisy internal space 28 of the apparatus 10, and further shields noise outputs from the noisy internal space 28 to the quiet external space 30. Shielding is accomplished while avoiding common impedance coupling and self inductance of the ground conductors in the modular jack 12 by shielding the receptacle jack 12 at the interface of the noisy interior space 28 of the apparatus 10 and the exterior of the modular jack 12. As such, the interior of the receptacle jack 12 becomes part of the quiet space 30.

More specifically, and as explained further below, the shield 14 includes magnetic components 32 on an exterior surface 34 thereof which remove undesirable noise from signals passing through the modular jack 12 as the signals pass from noisy space 28 to quiet space 30, and vice versa.

FIG. 2 illustrates the modular receptacle jack 12 including a generally rectangular housing 40 having a top wall 42, a bottom wall 44, opposite side walls 46 and 48, a front face 50 and a rear face 52. The front face 50 defines a jack interface 20 which opens to a receptacle 54 that receives a modular plug 22 (shown in FIG. 1). Contacts (not shown in FIG. 2) extend into the receptacle 54 within the housing 40 and establish electrical connection with corresponding contacts in the modular plug 22. In one embodiment, the modular jack 12 is an RJ-45 jack familiar to those in the art, although it is contemplated that the benefits of the present invention will accrue to other types of modular jacks as well.

In an illustrative embodiment, the housing 40 is plated with a conductive material, thereby providing an integral conductive shell about the contacts of the modular jack 12.

The shield 14 in the illustrated embodiment is coupled to the rear face 52 opposite the jack interface 20, and thus separates the noisy interior space 28 (shown in FIG. 1) from the quiet space 30 (also shown in FIG. 1) along an interface parallel to the rear face 52 of the housing 40. It is recognized, however, that the shield 14 could alternatively be coupled elsewhere on another wall of the housing 40 of the modular jack 12 to provide a differently oriented interface between the noisy interior space 28 and the quiet external space 30 without departing from the scope of the invention.

In an exemplary embodiment, the shield 14 is a printed circuit board having an interior or front surface 56 facing the housing 40 of the modular jack and an exterior or rear surface 58 facing away from, or external to, the housing 40. A number of signal conductors 60 extend through the shield 14 from the front surface 40 to the rear surface 40. The signal conductors 60 are each in electrical contact with a respective one of the contacts of the modular jack 12. FIG. 2 illustrates eight conductors 60 integrated into the shield 14, and the shield 14 thus is well suited for a four pair, eight signal contact modular jack 12. It is anticipated, however, that greater or fewer conductors 60 may be employed in alternative embodiments of the invention.

Magnetic components 32 (shown in FIG. 1) are mounted to the exterior or rear surface 58 of the shield, and the magnetic components 32 remove noise from the signal conductor paths 60 as the signals pass through an interface from noisy space 28 (shown in FIG. 1) to quiet space 30 (shown in FIG. 1) through the shield 14. The magnetic components 32 remove noise from the signal conductor paths 60 in the opposite direction as well. Clean, bi-directional communication is therefore facilitated by the shield 14. Incoming noise and outgoing noise are each effectively addressed, while avoiding self inductance in the ground path and the resultant common impedance coupling of the signal lines in the modular jack 12.

While the illustrated embodiment includes the magnetic components 32 on the rear surface 58 of the shield 14, it is understood that magnetic components 32 may likewise be located on the interior surface 56 if desired to shield the modular jack 12 along the interface between the noisy space 28 and the quiet space 30.

In the illustrated embodiment, the shield 14 includes a number of pins 62 extending from a lower edge thereof for connection to a printed circuit board, such as the motherboard 26 shown in FIG. 1. One pin 62 is provided for each of the signal conductors 60 passing through the shield 14. Pins 62 in various embodiments may be compliant pin leads, eye of the needle leads, or other known through-hole mounting structure familiar to those in the art. It is recognized, however, that surface mount connection schemes, edge card connection schemes, and other connection methods may be employed in lieu of through-hole technology with pins 62.

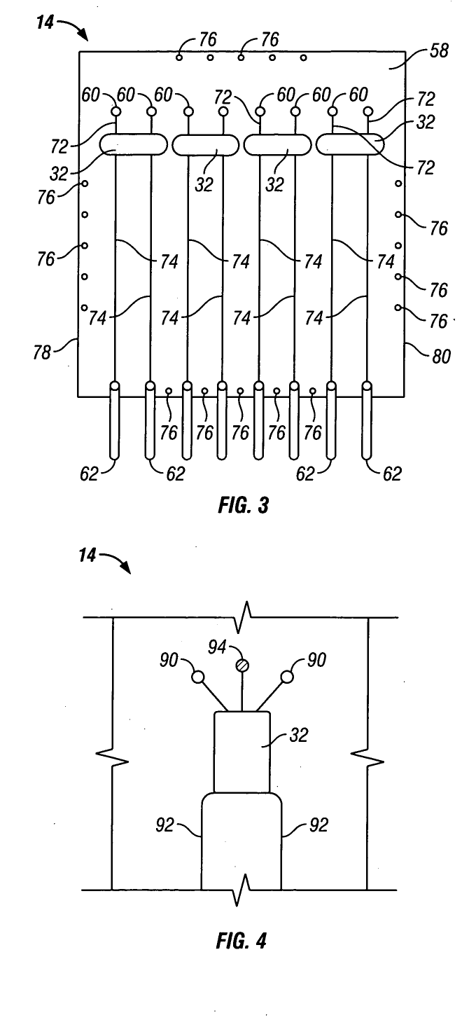

FIG. 3 is a schematic illustration of a rear side 58 of the shield 14 including the signal conductors 60 penetrating the surface of the rear side 58. Magnetic components 32 are mounted to the surface 58 of the shield 14 adjacent the conductors 60. The magnetic components 32 are electrically connected to the signal conductors 60 via conductive traces or paths 72. Conductive traces or paths 74 connect the magnetic components 32 to the signal pins 62, thereby completing a circuit path through the shield 14. Mounting apertures 76 are located adjacent the edges of the shield 14. Alternatively, grounding fingers on the edges of a separate conductive shell may make connection to the edges of the shield 14. The shield 14 may be coupled to the modular jack 12 (shown in FIGS. 1 and 2) via the apertures 76.

FIG. 4 is a magnified view of a portion of the shield 14 and illustrates an exemplary magnetic component 32. In an illustrative embodiment, the magnetic component 32 is a center tap transformer having two signal output terminals 90, two signal input lines 92 for the differential pair signals of the modular jack 12 (shown in FIGS. 1 and 2), and a common or ground terminal 94. The component 32 strips undesirable EMI/RFI noise at high frequencies from the signal lines 92 and outputs clean signals to the signal lines 90. A center tap transformer as a magnetic component 32 is believed to be acceptable for lower frequency communication (e.g., about 1 MHz to about 400 MHz) between the apparatus 10 (shown in FIG. 1) and a networked device.

In another exemplary embodiment, the magnetic component 32 is a common mode choke transformer which strips the signal lines 92 of undesirable common mode noise. In yet another exemplary embodiment, a magnetic component 32 may include filtering with a capacitor, or a capacitor feed through filter to filter undesirable noise from the signal lines. Of course, other magnetic components may be employed as magnetic components 32 to strip noise from the signal lines.

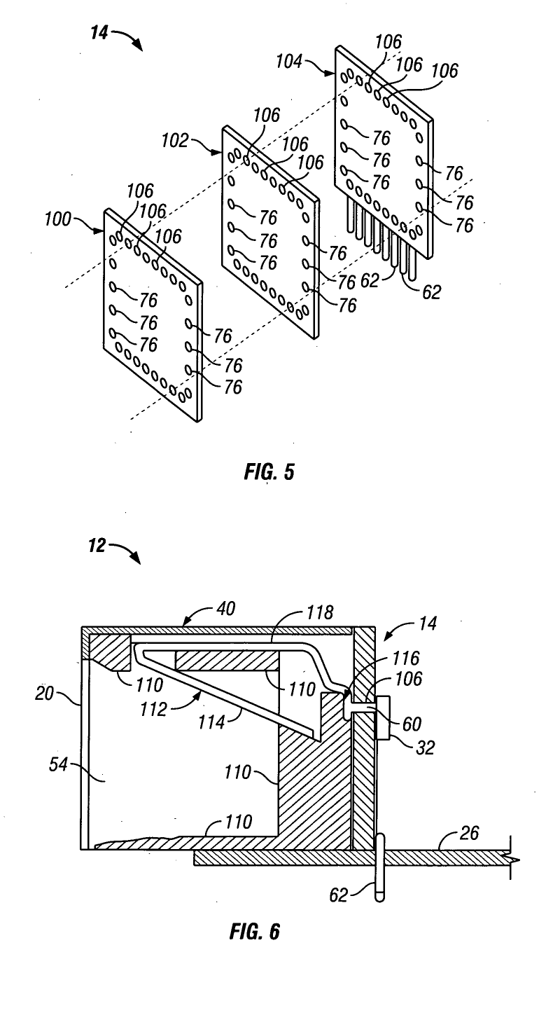

FIG. 5 is an exploded view of an exemplary shield 14 having a layered construction including an interior layer 100, a ground plane 102, and an exterior layer 104. Each of the layers 100 and 104 and the ground plane 102 include mounting apertures 76 extending therethrough for electrically connecting the shield 14 to the modular jack 12 (shown in FIGS. 1 and 2). Each of the layers 100 and 104 and the ground plane 102 further include signal apertures 106 extending therethrough for passage of the signal conductors 60 (shown in FIGS. 2 and 3).

Each of the layers 100 and 104 and the ground plane are fabricated from known circuit board materials and are sandwiched together by known processes and techniques. The signal conductors 60 may be formed in the signal apertures 106 via known methods and techniques, including but not limited to deposition processes, plating processes, and castellation processes, to name a few. Alternatively, separate signal wires or conductor elements may be inserted through the signal apertures 106 to establish a conductive path through the signal apertures 106 in the shield 14. The same is true for the mounting apertures 76.

In further and/or alternative embodiments, greater or fewer layers could be provided in the fabrication of the shield 14 to achieve particular product specifications and to accommodate particular applications. The magnetic components may be placed on more than one of the layers of the shield 14 to accommodate space limitations for selected magnetic components and the number of signals transmitted in selected modular jacks.

FIG. 6 is a cross sectional view of the modular jack 12 with the shield 14 fastened to the housing 40 of the jack, and with the jack 12 electrically coupled to the motherboard 26 of the apparatus 10 (shown in FIG. 1). The jack interface 20 opens to the plug receptacle 54 which is defined by interior walls 110 of the jack 12. In an exemplary embodiment, a plurality of stamped, metallic elongated contacts 112 are mounted in the receptacle 54 for engaging contacts (not shown) of the corresponding plug 22 (shown in FIG. 1). In an illustrative embodiment, each contact 112 includes a contact mating portion 114 at one end extending diagonally into the receptacle 54, a vertically extending lead portion 116 at the other end, and a horizontally extending intermediate portion 118 between the contact mating portion 114 and the lead portion 116. It is recognized, however, that contacts of other shapes and configurations may likewise be employed in further and/or alternative embodiments.

The lead portions 116 of the contacts 112 are in electrical contact with a respective one of the signal conductors 60 which passes through a respective signal aperture 106 in the shield 14. The magnetic components 32 are, in turn, electrically coupled to the signal conductors 60 and located adjacent the apertures 106, and the magnetic components 32 are connected to the terminal pins 62. The terminal pins 62 establish electrical communication with the mother board 26. Bi-directional signal communication is therefore possible between the mother board 26 and the contacts 112 of the modular jack 12, and by directly grounding magnetic components to a shield conductor, common impedance coupling is reduced and incoming and outgoing noise is effectively eliminated.

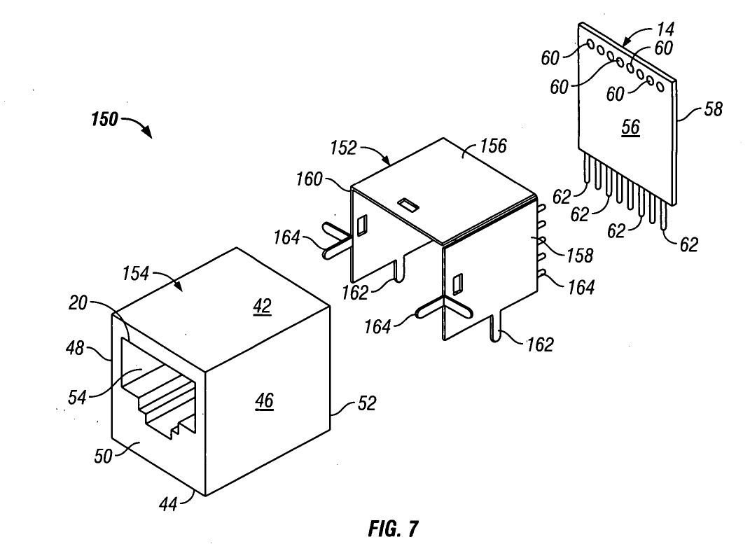

FIG. 7 illustrates another embodiment of a shielded modular jack 150 in which like features of the jack 12 (shown in FIGS. 1, 2, and 6 and described above) are indicated with like reference numbers. Unlike the jack 12, the jack 150 includes a separately fabricated conductive shell 152 secured to an insulative housing 154. Additionally, the shell 152 may be electrically connected to a bezel, such as the bezel 18 (shown in FIG. 1). In one embodiment, the electrical connection is by a ground finger or fingers 164 on the side walls 158 and 160 (as shown in FIG. 7). A ground finger 164 may also be provided on the front end of the top wall in conjunction with or in lieu of ground fingers on the side walls 158 and 160.

As illustrated in FIG. 7, the shell 152 includes a top wall 156, and side walls 158 and 160 which cover the respective top wall 42 and side walls 46 and 48 of the housing 154. Ground fingers 162 may be provided and depend downwardly from bottom edges of the side walls 158, 160 of the shell 152 and establish an electrical connection with a ground plane (not shown) of a circuit board.

The shield 14 is coupled to the conductive shell 152 and magnetic components such as those described above are coupled to the shield 14 for suppressing EMI/RFI substantially as described above. In one embodiment, the shell 152 includes a rear face and the shield 14 is coupled to the rear face. In another embodiment, the shell includes ground fingers 164 extending rearwardly from the side walls 158 and 160 of the shell 152 which establish electrical connection to the shield 14 when the jack 150 is assembled.

By directly grounding the magnetic components of the shield 14 to the conductive shell 152, common impedance coupling is reduced and incoming and outgoing noise is effectively eliminated.

While the invention has been described in terms of various specific embodiments, those skilled in the art will recognize that the invention can be practiced with modification within the spirit and scope of the claims.

1. A modular receptacle jack comprising:
a housing comprising a jack interface and an exterior surface;
a shield extending over at least a portion of said exterior surface, said shield comprising an interior face, an exterior face and signal conductors extending therebetween; and
a plurality of magnetic components coupled to one of said interior face and said exterior face for suppressing EMI/RFI in incoming and outgoing signals transmitted through the signal conductors.

2. A modular receptacle jack in accordance with claim 1 wherein said receptacle jack is an RJ-45 jack.

3. A modular receptacle jack in accordance with claim 1 wherein at least some of said magnetic components comprise transformer elements.

4. A modular receptacle jack in accordance with claim 1 wherein at least some of said magnetic components comprise capacitors.

5. A modular receptacle jack in accordance with claim 1 wherein said shield comprises a printed circuit board.

6. A modular receptacle jack in accordance with claim 1 wherein said shield comprises a printed circuit board, said printed circuit board comprising a ground plane.

7. A modular receptacle jack in accordance with claim 1 further comprising a conductive shell surrounding at least a portion of said jack, said shield coupled to said conductive shell.

8. A modular receptacle jack, comprising:
a housing comprising a jack receptacle and a plurality of signal contacts within said receptacle; and
a shield extending over an outer surface of said housing, said shield comprising a printed circuit board and a plurality of magnetic components coupled to a surface of said printed circuit board for suppressing EMI transmission by said contacts as signals pass from the signal contacts within the housing to an external space and as signals pass from the external space to the signal contacts.

9. A modular receptacle jack in accordance with claim 8 wherein said shield comprises opposite surfaces, and a conductive path extending from one of said surfaces to the other of said surfaces of said printed circuit board.

10. A modular receptacle jack in accordance with claim 8 wherein said contacts are electrically coupled to an inner surface of said printed circuit board.

11. A modular receptacle jack in accordance with claim 8 wherein said contacts are arranged in differential pairs.

12. A modular receptacle jack in accordance with claim 1 wherein said receptacle jack is an RJ-45 jack.

13. A modular receptacle jack comprising:
a housing comprising a jack receptacle and a plurality of signal contacts within said receptacle; and
a shield extending over an outer surface of said housing, said shield comprising a printed circuit board having at least one aperture therethrough for passage of a signal conductor, and at least one magnetic component coupled to a surface of said printed circuit board adjacent said aperture for suppressing EMI transmission therethrough thereby providing clean bi-directional communication through said signal contacts while avoiding common impedance coupling of said signal contacts.

14. A modular receptacle jack in accordance with claim 13 wherein said shield comprises opposite surfaces, said signal conductor extending from one of said surfaces to the other of said surfaces of said printed circuit board.

15. A modular receptacle jack in accordance with claim 13 wherein said shield comprises a plurality of apertures and signal conductors corresponding to each of said signal contacts, each of said signal contacts electrically coupled to one of said signal conductors.

16. A modular receptacle jack in accordance with claim 15 further comprising a plurality of magnetic components coupled to a surface of said shield, said magnetic components suppressing EMI/RFI transmission through each of said plurality of signal conductors.

17. A modular receptacle jack in accordance with claim 15 wherein said contacts are arranged in differential pairs.

18. A modular receptacle jack in accordance with claim 15 wherein said receptacle jack is an RJ-45 jack.

19. A modular jack in accordance with claim 15 further comprising a conductive shell surrounding a portion of said housing, said shield coupled to said conductive shell.

20. A modular jack in accordance with claim 15 further comprising a conductive shell surrounding a portion of said housing, said shell having ground fingers electrically contacting said shield.
